(19) United States
(12) Patent Application Publication
(10) Pub. No.: US 2024/0297937 A1
(43) Pub. Date: Sep. 5, 2024

(54) METHOD FOR MANAGING AN AUDIO AND/OR VIDEO CONFERENCE

(71) Applicant: Orange, Issy-les-Moulineaux (FR)

(72) Inventors: Julien Faure, CHATILLON CEDEX (FR); Jean Francois Letellier, CHATILLON CEDEX (FR); Sonia Laurent, CHATILLON CEDEX (FR)

(21) Appl. No.: 18/571,955

(22) PCT Filed: Jun. 20, 2022
(86) PCT No.: PCT/FR2022/051191

§ 371 Date: Dec. 19, 2023

(30) Foreign Application Priority Data
Jun. 23, 2021 (FR) FR2106700

(51) Int. Cl. H04M 3/56

(52) U.S. Cl. CPC H04M 3/568

(57) ABSTRACT

A method implemented by a first client terminal during an audio and/or video conference in conjunction with a conference server that manages audio data stream exchanges is described. The method includes obtaining a stream of tagged audio data by embedding a digital tag code; sending the stream of tagged audio data to the conference server; receiving audio capability data representative of whether a second client terminal has detected the digital tag code in an audio data stream; and activating, based on the received audio capability data, at least one management action of the audio and/or video conference, including reproducing items of information according to the received audio capability data.

### TECHNICAL FIELD

The invention relates to the field of audio conferences and video conferences, and relates more particularly to the ability of a user to be heard or not heard by another user during an audio conference or video conference.

### PRIOR ART

Video conference or audio conference systems have grown significantly in recent years, and this trend has grown even further in the current health context. An audio conference allows participants to communicate instantaneously by audio, while a video conference allows instantaneous communication not only by audio but also by images. In other words, during a video conference, video streams are exchanged between the terminals of the participants so that everyone is able to see and hear their discussion partners. During an audio conference, audio streams are exchanged without an image stream being present.

Communication conferences, such as audio conferences and video conferences, are solutions that allow multiple participants to communicate with one another effectively by way of client terminals. However, these tools are sometimes tricky to use for the uninitiated, and technical issues regularly prevent participants from enjoying a good user experience. In particular, one recurring problem arises in that it is not always possible for a participant to know whether they are, or will be, heard well by other participants during an audio or video conference. This uncertainty often prompts participants to ask their discussion partners whether they are being heard well by everyone, which may bring about confusion, annoyance for participants (waste of time, etc.), and this method does not provide assurance that all participants are actually hearing the speaker in question well, in particular when a large number of users are participating in the conference.

These problems with regard to good audio reception pose a challenge insofar as many technical problems are likely to prevent a participant from being heard well by their discussion partners (configuration problems, hardware problems, incorrect use of tools, etc.).

The technical constraints and limitations mentioned above may therefore degrade user experience and limit the benefit of these communication tools for certain users or in certain contexts.

### SUMMARY OF THE INVENTION

To this end, the present invention relates to a first method implemented by a first client terminal during a communication session in cooperation with an audio and/or video conference server managing exchanges of audio data streams between the first client terminal and at least one second client terminal during an audio and/or video conference.

According to the present application, the first method comprises:
sending, to the audio and/or video conference server, a marked audio data stream, the audio data being marked by integrating a code assigned to said first terminal into a first audio data stream;
receiving audio capability data representative of whether said at least one second client terminal has detected the code assigned to said first terminal in an audio data stream received from the audio and/or video conference server; and
triggering at least one action of managing the audio and/or video conference based on the received audio capability data, said at least one management action comprising:
   rendering, via a user interface of the first client terminal, information dependent on the received audio capability data, indicating whether said at least one second client terminal is able to receive an audio data stream from the first client terminal.

According to at least one embodiment, the first method comprises receiving, from a mediation server (SV2), the code assigned to the first client terminal.

According to at least one embodiment, said code assigned to said first client terminal is received in response to a request to said mediation server comprising an identifier of the first client terminal.

According to at least one embodiment, the first audio data stream is generated from acoustic signals acquired by a first microphone coupled to the first client terminal.

According to at least one embodiment, the acoustic signals from which the first audio data stream is generated represent background noise acquired by the first microphone, the intensity of the background noise being less than a first intensity value.

According to at least one embodiment, the first method comprises the first audio data stream being generated by emulating random noise.

According to at least one embodiment, the first method comprises, prior to sending the marked audio data stream to the audio and/or video conference server:
activating the first microphone of the first client terminal;
deactivating an echo cancellation function so as to allow acoustic acquisition, by the first microphone of the first client terminal, of an acoustic emission from a first loudspeaker coupled to said at least one first client terminal;
generating an acoustic test signal by way of the first loudspeaker;
acoustically acquiring, by way of the first microphone, the acoustic test signal transmitted by the first loudspeaker; and
determining, based on a result of said acoustic acquisition, acoustic capability data
characterizing acoustic capabilities of the first microphone;
wherein the information rendered by the user interface is furthermore representative of the acoustic capabilities of the first microphone of the first client terminal.

According to at least one embodiment, the first method comprises:
a) obtaining a marked audio data stream, the audio data being marked by integrating a digital marking code into a first audio data stream by watermarking;
b) sending the marked audio data stream to the audio and/or video conference server;
c) receiving, from a mediation server, audio capability data representative of whether said at least one second client terminal has detected the digital marking code in an audio data stream received from the audio and/or video conference server; and
d) triggering at least one action of managing the audio and/or video conference based on the received audio capability data, said at least one management action comprising:
   rendering, via a user interface of the first client terminal, information dependent on the received audio capability data, indicating whether said at least one second client terminal is able to receive an audio data stream from the first client terminal.

As already indicated, it is not always easy for a user participating in an audio and/or video conference to know whether they are, or whether they will be, heard well by the other participants when they are speaking or when they are preparing to speak during an audio and/or video conference. Various hardware, software or other problems are likely to hinder the correct transmission of an audio stream from the client terminal of the speaker in question to the client terminals of other participants. The use, in some embodiments of the invention, of a digital marking technique (also known as watermarking) may help to reliably and robustly test the ability of client terminals to receive audio data streams from a given client terminal during an audio and/or video conference. The invention may thus help to limit the risks of a user speaking without being heard by another participant in the audio and/or video conference.

According to at least one embodiment, the obtaining a) comprises:
e) sending, to a mediation server, a digital marking code request, said request comprising an identifier of the first client terminal;
f) receiving, in response to said request, the digital marking code assigned to the first client terminal.

According to at least one embodiment, the first method comprises:
determining, when establishing the communication session, an identifier of the audio and/or video conference; and
inserting, into the digital marking code request, the identifier of the audio conference before sending to the mediation server, so as to enable said mediation server to record the digital marking code in association with the identifier of the first client terminal and the identifier of the audio and/or video conference.

The use of an identifier of the audio and/or video conference may in particular enable the mediation server to recognize a request associated with the audio and/or video conference in progress, and thus to obtain or generate a unique code (such as a digital marking code for example) for the first client terminal. The mediation server may in particular supervise an audio stream reception test for a plurality of distinct audio and/or video conferences, including when the first client terminal T1 participates in several conferences simultaneously or successively over a given period.

According to at least one embodiment, the first audio data stream is generated from acoustic signals acquired by a first microphone coupled to the first client terminal. It is thus possible to carry out an audio test while transmitting sounds from the first client terminal to the second client terminal during the audio and/or video conference.

According to one particular embodiment, the acoustic signals from which the first audio data stream is generated represent background noise acquired by the first microphone, the intensity of the background noise being less than a first intensity value. It is thus possible to carry out an audio test while the user of the first client terminal is silent (not speaking) during the conference in progress.

According to at least one embodiment, the sending of the digital marking code request is triggered upon detection, by way of the first microphone of the first client terminal, of a period of silence of a duration at least equal to a first duration, during which background noise of an intensity less than said first intensity value is detected. It is thus possible to trigger an audio test automatically when the user of the first client terminal is silent (not speaking) during the conference in progress.

According to at least one embodiment, sending of the digital marking code request is triggered upon detection that the first microphone is deactivated for at least a second duration.

According to at least one embodiment, the first audio data stream is generated by emulating random noise. It is thus possible, at least in some embodiments, to carry out an audio test in a reliable and robust manner, independently of any audio data stream liable to be transmitted by the first client terminal during the conference in progress.

According to at least one embodiment, at least some of steps a)-d) of the method implemented on the first client terminal may be reiterated during said communication session so as to check, multiple times (for example periodically), whether said at least one second client terminal is able to receive an audio data stream transmitted by the first client terminal. It is thus possible to check, over a given period, repeatedly (periodically or regularly) or continuously, whether the second client terminal is able to receive an audio data stream transmitted by the first client terminal during the conference in progress.

According to at least one embodiment, if the received audio capability data represent the fact that said at least one second client terminal has detected the digital marking code in an audio data stream received from the audio conference server, then the information rendered by the user interface indicates that said at least one second client terminal is able to receive an audio data stream transmitted by the first client terminal. The user of the first client terminal may thus be certain that they are or will be heard well during the conference in progress.

According to at least one embodiment, the first client terminal sends, to the mediation server, a notification informing that the marked data stream has been sent to the audio and/or video conference server. It is thus possible for the mediation server to be informed when an audio test is initiated by the first client terminal. Based on this notification, the mediation server may in particular determine whether it receives a notification from the second client terminal indicating that said second client terminal has detected the digital marking code.

According to at least one embodiment, said at least one management action comprises:
if the received audio capability data represent the fact that said at least one second client terminal has not detected the digital marking code in the mixed audio data stream received from the audio conference server, changing an audio configuration of the first client terminal.

It is thus possible for example for the first client terminal to adapt its configuration when an audio stream reception problem is detected, and therefore improve the chances of the user of the first client terminal being heard by the second client terminal during the conference.

According to one particular embodiment, the first method comprises, successively for each of a plurality of audio configurations, for as long as a first audio condition is not satisfied:
configuring the first client terminal in accordance with said audio configuration; and
reiterating at least some of steps a)-d).

According to at least one embodiment, the first method comprises, prior to sending the marked audio data stream to the audio and/or video conference server:
activating the first microphone of the first client terminal;
deactivating an echo cancellation function so as to allow acoustic acquisition, by the first microphone of the first client terminal, of an acoustic emission from a first loudspeaker coupled to said at least one first client terminal;
generating an acoustic test signal by way of the first loudspeaker;
acoustically acquiring, by way of the first microphone, the acoustic test signal transmitted by the first loudspeaker; and
determining, based on a result of said acoustic acquisition, acoustic capability data characterizing acoustic capabilities of the first microphone;
wherein the information rendered in d) by the user interface is furthermore representative of the acoustic capabilities of the first microphone of the first client terminal.

It is thus possible to test the acoustic processing chain at the first client terminal.

According to at least one embodiment, the first method furthermore comprises:
receiving, from the mediation server, acoustic capability data representative of acoustic capabilities of a second loudspeaker coupled to said at least one second client terminal to produce an acoustic output;
the information rendered in d) by the user interface furthermore being representative of the acoustic capabilities of the second loudspeaker of the second client terminal.

The user of the first client terminal may thus be informed of the ability of the acoustic processing chain of the first client terminal to produce an acoustic emission (output).

The invention also relates to a second method implemented by a second client terminal during a communication session in cooperation with an audio and/or video conference server managing exchanges of audio data streams between a first client terminal and the second client terminal during an audio and/or video conference.

According to the present application, the second method comprises:
receiving an audio data stream from the audio and/or video conference server; and
sending a notification comprising a code integrated into said received audio data stream, in association with an identifier of the second client terminal.

According to at least one embodiment, the second method furthermore comprises, upon detection of said code in said received audio data stream:
activating (C100) a second microphone (MIC2) coupled to the second client terminal;
deactivating (C102) an echo cancellation function (F2) so as to allow acoustic acquisition, by the second microphone, of an acoustic emission from a second loudspeaker (HP2) coupled to said second client terminal;
generating (C104) an acoustic test signal (SA2) by way of the second loudspeaker;
acoustically acquiring (C106), by way of the second microphone, the acoustic test signal transmitted by the second loudspeaker;
determining (C108), based on a result of said acoustic acquisition, acoustic capabilities (DTB2) of the second loudspeaker of the second client terminal to produce an acoustic emission; and
sending the acoustic capabilities of the second loudspeaker to the mediation server (SV2).

According to at least one embodiment, the second method comprises:
g) receiving, from the audio and/or video conference server, a marked audio data stream;
h) detecting, in the marked audio stream, a digital marking code integrated into the marked audio data stream by watermarking; and
i) sending, to a mediation server, a notification indicating the detection of the digital marking code, said notification comprising the digital marking code in association with an identifier of the second client terminal.

The sending of said notification to the mediation server enables said server to generate audio capability data indicating whether the second client terminal has detected the code integrated into the received stream. The mediation server may in particular transmit these audio capability data to the first client terminal in order to indicate thereto whether or not the second client terminal is able to receive an audio stream transmitted by the first client terminal during the conference.

According to at least one embodiment, the second method furthermore comprises, in response to the detection h):
activating a second microphone coupled to the second client terminal;
deactivating an echo cancellation function so as to allow acoustic acquisition, by the second microphone, of an acoustic emission from a second loudspeaker coupled to said second client terminal;
generating an acoustic test signal by way of the second loudspeaker;
acoustically acquiring, by way of the second microphone, the acoustic test signal transmitted by the second loudspeaker;
determining, based on a result of said acoustic acquisition, acoustic capabilities of the second loudspeaker of the second client terminal to produce an acoustic emission; and
sending the acoustic capabilities of the second loudspeaker to the mediation server.

It is thus possible to test the acoustic processing chain at the second client terminal. The invention also targets a third method implemented by a system, comprising a first client terminal and a second client terminal respectively executing the first and second methods defined above, in at least some of their embodiments, and described in particular examples below.

More particularly, the invention targets a third method implemented by a client system, comprising a first client terminal and a second client terminal, during a communication session in cooperation with an audio and/or video conference server managing exchanges of audio data streams between the first client terminal and the second client terminal during an audio and/or video conference,
wherein the first terminal executes a first method as defined above;
wherein the second terminal executes a second method as defined above;
the information rendered in d) by the first client terminal indicating that the second client terminal is able to receive an audio data stream transmitted by the first client terminal.

According to at least one embodiment, the third method furthermore comprises (for example in response to the detection h)) the following steps implemented by said second client terminal:
activating a second microphone coupled to the second client terminal;
deactivating an echo cancellation function so as to allow acoustic acquisition, by the second microphone, of an acoustic emission from a second loudspeaker coupled to said second client terminal;
generating an acoustic test signal by way of the second loudspeaker;
acoustically acquiring, by way of the second microphone, the acoustic test signal transmitted by the second loudspeaker;
determining, based on a result of said acoustic acquisition, acoustic capabilities of the second loudspeaker of the second client terminal to produce an acoustic output; and sending the acoustic capabilities of the second loudspeaker to the mediation server;
the method furthermore comprising the following step implemented by the first client terminal:
receiving, from the mediation server, acoustic capability data representative of said acoustic capabilities of the second loudspeaker of the second client terminal; the information rendered in d) by the first client terminal furthermore being representative of the acoustic capabilities of the second loudspeaker of the second client terminal.

The invention also targets a fourth method implemented by a mediation server in cooperation with a plurality of client terminals (comprising a first client terminal and a second client terminal) participating in an audio and/or video conference during which audio data streams are exchanged via an audio and/or video conference server.

According to the present application, the fourth method comprises:
sending, to a first client terminal, a code assigned to the first client terminal and recorded, in association with an identifier (ID1) of the first client terminal;
upon receipt, from a second client terminal, of a notification comprising the code assigned to said first client terminal in association with an identifier of the second client terminal;
determining audio capability data indicating whether the second client terminal is able to receive an audio data stream from the first client terminal; and
sending said audio capability data to the first client terminal.

According to at least one embodiment, absence of reception of said notification is determined if no said notification, indicating that the second client terminal (T2) has detected the code assigned to said first terminal, is received within a first period starting from a reference time.

More specifically, according to at least one embodiment, the fourth method comprises:
j) sending, to a first client terminal, a digital marking code assigned to the first client terminal and recorded, in marking data of said mediation server, in association with an identifier of the first client terminal;
k) determining, based on the marking data, whether a notification indicating that a second client terminal has detected the digital marking code is received from said second client terminal, said notification comprising the digital marking code in association with an identifier of the second client terminal;
l) determining, based on a result of the determination k), audio capability data indicating whether the second client terminal is able to receive an audio data stream from the first client terminal; and
m) sending the audio capability data to the first client terminal.

The mediation server is thus capable of supervising the audio test initiated by the first client terminal in order to evaluate whether the second client terminal is able to receive an audio data stream transmitted by the first client terminal during the conference.

According to at least one embodiment, absence of reception of said notification is determined in k) if no said notification, indicating that the second client terminal has detected the digital marking code, is received within a first period starting from a reference time. The mediation server is thus able to determine that the second client terminal has not detected the digital marking code if said mediation server does not receive any notification in this sense from the second client terminal.

According to one particular embodiment, the mediation server executes steps j) to m) for a plurality of second client terminals, so as to send, in m), to the first client terminal, audio capability data in relation to each of the plurality of second client terminals.

The mediation server is thus able to supervise audio tests initiated by the first client terminal so as to evaluate whether a plurality of second client terminals participating in the conference are able to receive an audio data stream transmitted by the first client terminal.

According to one particular embodiment, the various steps of the first, second, third and fourth methods as defined above, and as described below in particular examples, are determined by computer program instructions.

As a result, the invention also targets computer programs on information media (or recording media), these programs being able to be implemented in terminals or in servers, or more generally in computers, these programs comprising instructions designed to implement the steps of the first, second, third and fourth methods, respectively. Thus, each of the methods of the invention may be implemented by way of a non-volatile memory storing computer program instructions and a processor executing these instructions.

According to one embodiment, the various methods of the invention are implemented by way of software components and/or hardware components. With this in mind, the term “module” may correspond in this document equally to a software component, to a hardware component or to a set of software components and hardware components.

A software component corresponds to one or more computer programs, one or more subroutines of a program, or more generally to any element of a program or of software able to implement a function or a set of functions, in accordance with what is described below for the module in question. Such a software component may be executed by a data processor of a physical entity (terminal, server, gateway, router, etc.) and is capable of accessing the hardware resources of this physical entity (memories, recording media, communication buses, input/output electronic cards, user interfaces, etc.).

In the same way, a hardware component may correspond to any element of a hardware assembly able to implement a function or a set of functions, in accordance with what is described below for the module in question. This may be a programmable hardware component or a hardware component with an integrated processor for executing software, for example an integrated circuit, a chip card, a memory card, an electronic card for executing firmware, etc.

The present invention also targets a first client terminal (and respectively a second client terminal) configured to implement the first method (and respectively the second method) of the invention as defined above and described below in particular examples.

The present invention also targets a system comprising the first and second client terminals of the invention, configured to implement the third method of the invention.

The present invention also targets a mediation server configured to implement the fourth method of the invention as defined above and described below in particular examples.

It should be noted that the various embodiments mentioned above (as well as those described below) in relation to the various methods of the invention, as well as the associated advantages, apply analogously to the client terminals, system and mediation server of the invention.

For each step of the methods of the invention, the associated device (or physical entity) of the invention (first client terminal; second client terminal, system, mediation server) may comprise a corresponding module configured to carry out said step.

### BRIEF DESCRIPTION OF THE DRAWINGS

Other features and advantages of the present invention will become apparent from the description given below with reference to the appended drawings, which illustrate embodiments thereof that are in no way limiting. In the figures:

FIG. 1 schematically shows an environment comprising client terminals and a mediation server, according to one particular embodiment of the invention;

FIG. 2 schematically shows a first client terminal according to at least one embodiment of the invention;

FIG. 3 schematically shows a second client terminal according to at least one embodiment of the invention;

FIG. 4 schematically shows a mediation server according to at least one embodiment of the invention;

FIG. 5 shows, in the form of a diagram, the steps of methods implemented by client terminals and by a mediation server, according to some embodiments of the invention;

FIG. 6 shows, in the form of a diagram, the steps of methods implemented by client terminals and by a mediation server, according to some embodiments of the invention;

FIG. 7 shows, in the form of a diagram, the steps of a method implemented by a first client terminal, according to at least one embodiment of the invention; and

FIG. 8 shows, in the form of a diagram, the steps of a method implemented by a second client terminal, according to at least one embodiment of the invention.

### DESCRIPTION OF THE EMBODIMENTS

As indicated above, the present application relates to the communication of users during an audio conference or video conference. By definition, audio and/or video conferences involve the exchange of at least audio data. Audio conferences thus involve exchanges of audio streams, while video conferences involve exchanges of image streams and audio streams (video streams).

The invention proposes in particular to enable a user participating in an audio and/or video conference (also referred to more simply as “conference”) to check that they are or will be heard by at least one other given participant. To this end, the invention, according to its various embodiments, uses a code, assigned to a first client terminal, such as a digital marking code, which is integrated into an audio data stream in order to determine whether at least one second client terminal is able to receive an audio data stream transmitted by the first client terminal.

Thus, according to at least some embodiments, a first client terminal may be configured to send a marked audio data stream to an audio and/or video conference server (also called “conference server”) managing exchanges of audio data streams between the first client terminal and at least one second client terminal during an audio and/or video conference. This marked audio data stream may comprise a code, such as a digital marking code, integrated into an audio data stream for example by watermarking. The first client terminal may furthermore receive, from a mediation server, audio capability data representative of whether said at least one second client terminal has detected the digital marking code in an audio data stream received from the audio and/or video conference server. It is thus possible for the first client terminal to determine whether said at least one second client terminal is able to receive an audio data stream from the first client terminal.

The invention furthermore targets in particular a second client terminal configured to process a marked audio data stream as indicated above, a corresponding mediation server, and corresponding methods and computer programs. Other aspects and advantages of the present invention will become apparent from the exemplary embodiments described below with reference to the figures mentioned above. In this document, exemplary implementations of the invention are described in the context of the management of an audio and/or video conference, where only the processing of audio data streams is taken into account. It will however be understood that the invention applies both in the context of an audio conference and in that of a video conference. Generally speaking, the invention makes it possible in particular to test the transmission/reception of audio data streams in a communication conference such as an audio conference or video conference.

Unless indicated otherwise, common or analogous elements in multiple figures bear the same reference signs and have identical or analogous features, and so these common elements are not generally described again for the sake of simplicity.

The terms “first”, “second”, etc. are used in this document by arbitrary convention to identify and distinguish various elements (such as terminals, method) implemented in the embodiments described below.

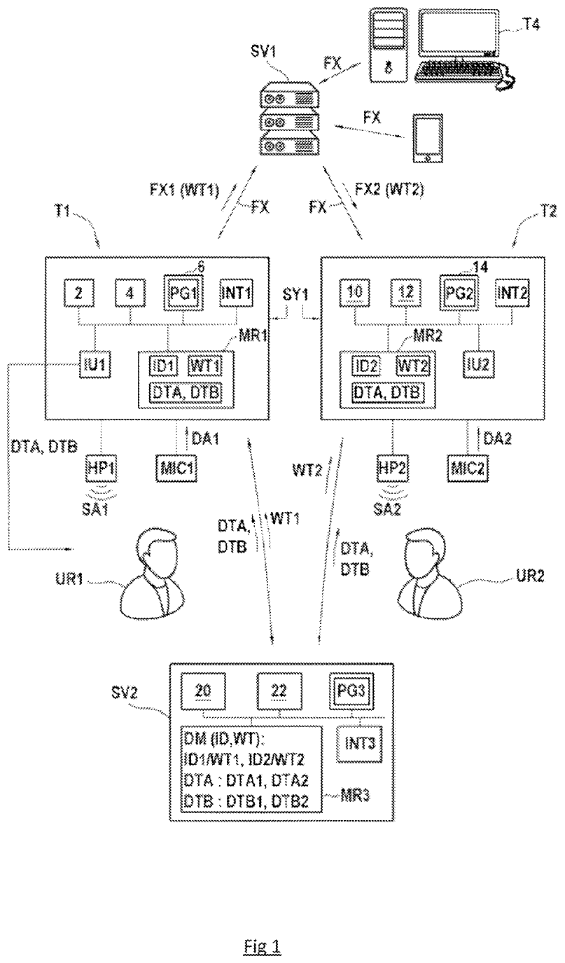

FIG. 1 schematically shows, by way of non-limiting example, an environment comprising a first client terminal T1, a second client terminal T2, an audio and/or video conference server SV1 and a mediation server SV2 (also called control server). In this example, the client terminals T1 and T2 are used by users UR1 and UR2, respectively, to communicate by audio during an audio and/or video conference.

To this end, the conference server SV1 manages exchanges of audio data streams FX between the client terminals participating in the conference.

It should be noted that the number and the nature of the client terminals participating in the communication session during the conference may vary on a case-by-case basis. In particular, the number of second client terminals within the meaning of the invention, for which the first client terminal T1 tests the audio reception, may vary on a case-by-case basis. By way of example, second client terminals T3 and T4 may also cooperate with the conference server SV1 and with the mediation server SV2, although implementations of the invention with only two client terminals, namely the first client terminal T1 and the second client terminal T2 in this example, are also possible. Therefore, the principle of the invention is described below in particular examples mainly involving the terminal T1 as first client terminal and the terminal T2 as second client terminal within the meaning of the invention. However, the invention may be applied analogously to a plurality of second client terminals (T2, T3 and/or T4 for example) operating as second terminals within the meaning of the invention. It should also be noted that each of the client terminals T1-T4 may furthermore be configured to act both as first terminal and as second terminal within the meaning of the invention.

It will be assumed that the client terminals are each able to cooperate with the conference server SV1 via any communication network, such as the Internet, or an Intranet network or any other appropriate network. The client terminals T1-T4 may be computers (PCs, laptops, etc.), tablets, smartphones or any other type of terminals able to exchange audio data streams during an audio and/or video conference with at least one other participant.

The conference server SV1 is configured to manage audio communications during a communication session established with the client terminals T1-T4 during an audio and/or video conference. To this end, the conference server SV1 is able to establish the communication session with each of the client terminals, and then to receive the audio data streams FX transmitted or generated by the client terminals T1-T4. The conference server SV1 then processes these audio data streams in order to redistribute them to the other participants. More particularly, the conference server SV1 may for example decode the received audio data streams FX using appropriate codecs (those used by the corresponding client terminals), mix these audio data and generate a mixed audio data stream by re-encoding the mixed audio data. This mixed audio data stream may then be sent to the various client terminals so that their users are able to hear all audio communications exchanged by the participants.

As shown in FIG. 1, the client terminals T1-T4 may also be able to cooperate with the mediation server SV2 via any appropriate communication network. As described in detail below, the mediation server SV2 may be configured for example to evaluate the audio capabilities of at least some of the client terminals and to transmit, to at least some of the client terminals, audio capability data DTA representative of audio capabilities of at least some of the client terminals T1-T4. To this end, the mediation server SV2 may transmit, to at least some of the client terminals (for example to each one), a code WT, such as a digital marking code, which is assigned thereto. These digital marking codes are intended for example to be integrated, by watermarking, into an audio data stream in order to carry out audio tests, as described below. By way of example, the mediation server SV2 may send digital marking codes WT1 and WT2 to the client terminals T1 and T2, respectively. As described below, these digital marking codes may be used thereafter to test the ability of client terminals to receive an audio data stream transmitted in particular from the first client terminal T1 in this example.

According to one particular example, the mediation server SV2 may also send, to the client terminals, acoustic capability data DTB (FIG. 1) representative of the acoustic capabilities of client terminals, as described below.

The structures of the client terminals and of the mediation server SV2 will now be described with reference to FIG. 1, according to particular embodiments.

Thus, according to one particular example shown in FIG. 1, the client terminal T1 comprises a processor 2, a volatile memory (RAM) 4, a non-volatile memory 6, a communication interface INT1, a user interface IU1 and a rewritable non-volatile memory MR1.

The memory 6 is for example a rewritable non-volatile memory or a read-only memory (ROM), this memory constituting a recording medium (or information medium) according to one particular embodiment, able to be read by the client terminal T1 and on which there is recorded a first computer program PG1 according to one particular embodiment. This computer program PG1 comprises instructions for executing the steps of a first method (also referred to as first management method) according to one particular embodiment, as described in more detail below.

The client terminal T1 is able to use its communication interface INT1 to communicate with the conference server SV1 and with the mediation server SV2. The nature of this interface depends on the type of communication network that is used.

The rewritable non-volatile memory MR1 (for example a flash or EEPROM memory) is able to store an identifier ID1 of the client terminal T1, a code, such as a digital marking code, WT1 and audio capability data DTA. Where applicable, the memory MR1 may also be used to store acoustic capability data DTB. In this example, it will be considered that a first loudspeaker HP1 and a first microphone MIC1 are coupled to the first client terminal T1 such that the user UR1 is able to hear and transmit audio communications during an audio and/or video conference. Variant embodiments without at least one of the loudspeaker HP1 and the microphone MIC1 are possible, however. The loudspeaker HP1 makes it possible to generate sounds (referred to as acoustic signals) from audio data, whereas the microphone MIC1 makes it possible to generate audio data by acoustically acquiring sounds (or acoustic signals). The loudspeaker HP1 and the microphone MIC1 constitute audio means that may be used by the processor 2 by way of an audio card and/or any other hardware means and/or software means that are configured according to a particular audio configuration.

As described below in particular examples, the loudspeaker HP1 may be configured to transmit in particular an acoustic test signal, denoted SA1, that the microphone MIC1 is able to acquire acoustically.

The processor 2 uses for example the volatile memory 4 to control the various components (memories, communication interface, etc.) and to carry out the various operations and functions necessary for the client terminal T1 to operate, including to execute the computer program PG1 during the implementation of the first method of the invention.

Although other implementations are possible, it will be assumed in this example that the second client terminal T2 has a structure identical to that of the first terminal T1, such that these two terminals are able to be used interchangeably to execute the first and second methods within the meaning of the invention.

According to one particular example shown in FIG. 1, the second client terminal T2 comprises a processor 10, a volatile memory (RAM) 12, a non-volatile memory 14, a communication interface INT2, a user interface IU2 and a rewritable non-volatile memory MR2.

The memory 12 is for example a rewritable non-volatile memory or a read-only memory (ROM), this memory constituting a recording medium (or information medium) according to one particular embodiment, able to be read by the client terminal T2 and on which there is recorded a second computer program PG2 according to one particular embodiment. This computer program PG2 comprises instructions for executing the steps of a second method (also referred to as second management method) according to one particular embodiment, as described in more detail below.

The client terminal T2 is able to use its communication interface INT2 to communicate with the conference server SV1 and with the mediation server SV2. As already indicated, the nature of this interface depends on the type of communication network that is used.

The rewritable non-volatile memory MR2 (for example a flash or EEPROM memory) is able to store an identifier ID2 of the client terminal T2, a digital marking code WT2 and audio capability data DTA. Where applicable, the memory MR2 may also be used to store acoustic capability data DTB.

In this example, it will be considered that a second loudspeaker HP2 and a second microphone MIC2 are coupled to the second client terminal T2 such that the user UR2 is able to hear and transmit audio communications during an audio and/or video conference. Variant embodiments without at least one of the loudspeaker HP2 and the microphone MIC2 are possible, however. The loudspeaker HP2 makes it possible to generate acoustic signals from audio data, whereas the microphone MIC2 makes it possible to generate audio data by acoustically acquiring acoustic signals. The loudspeaker HP2 and the microphone MIC2 constitute audio means that may be used by the processor 10 by way of an audio card and/or any other hardware means and/or software means that are configured according to a particular audio configuration.

As described below in particular examples, the loudspeaker HP2 may be configured to transmit in particular an acoustic test signal, denoted SA2, that the microphone MIC2 is able to acquire acoustically.

The processor 10 uses for example the volatile memory 12 to control the various components (memories, communication interface, etc.) and to carry out the various operations and functions necessary for the client terminal T2 to operate, including to execute the computer program PG2 during the implementation of the second method of the invention.

In this example, the first client terminal T1 and the second client terminal T2 together form a client system SY1, the latter possibly also comprising one or more other client terminals, such as the terminals T3 and/or T4 for example. The client system SY1 is configured to implement a third method within the meaning of the invention by executing the instructions of the computer programs PG1 and PG2 via the client terminals T1 and T2.

According to one particular example shown in FIG. 1, the mediation server SV2 comprises a processor 20, a volatile memory (RAM) 22, a non-volatile memory 24, a communication interface INT3 and a rewritable non-volatile memory MR3.

The memory 24 is for example a rewritable non-volatile memory or a read-only memory (ROM), this memory constituting a recording medium (or information medium) according to one particular embodiment, able to be read by the mediation server SV2 and on which there is recorded a third computer program PG3 according to one particular embodiment. This computer program PG3 comprises instructions for executing the steps of a fourth method according to one particular embodiment, as described in more detail below.

The mediation server SV2 is able to use its communication interface INT3 to communicate with the client terminals T1 and T2. As already indicated, the nature of this interface depends on the type of communication network that is used. In this example, the mediation server SV2 is also able to communicate, by way of its communication interface INT3, with the client terminals T3 and/or T4, although implementations without these additional client terminals are possible, as already indicated. The rewritable non-volatile memory MR3 (for example a flash or EEPROM memory) is able to store marking data DM and audio capability data DTA. The marking data DM comprise at least one digital marking code WT in association with an identifier ID of a respective client terminal to which said digital marking code WT has been assigned. The marking data DM may thus comprise a plurality of pairs (ID, WT), a distinct digital marking code WT being assigned to each client terminal.

The processor 20 uses for example the volatile memory 22 to control the various components (memories, communication interface, etc.) and to carry out the various operations and functions necessary for the mediation server SV2 to operate, including to execute the computer program PG3 during the implementation of the fourth method of the invention.

The nature and the configuration of the various elements (components, data, etc.) mentioned above in relation to the client terminals and the mediation server SV2 will become more clearly apparent in the exemplary embodiments described below with reference to FIGS. 2-8. It should be noted that the elements shown in FIG. 1 constitute only particular exemplary embodiments, other implementations being possible within the scope of the invention. Those skilled in the art will understand in particular that some elements of the environment under consideration are described here only to facilitate understanding of the invention, these elements not being necessary to implement the invention. As shown in FIG. 2, according to one particular embodiment, the processor 2 driven by the computer program PG1 implements here a certain number of modules in the first client terminal T1, namely: an obtainment module MD2, a sending module MD4, a reception module MD6, a control module MD8, and possibly also an acoustic test module MD10.

The obtainment module MD2 is configured to obtain a marked audio data stream FX1, the audio data being marked by integrating a digital marking code WT1 into a first audio data stream by watermarking. As described below, this marked audio data stream FX1 may be obtained in various ways by the first client terminal T1.

The sending module MD4 is configured to send the marked audio data stream FX1 to the audio and/or video conference server SV1.

The reception module MD6 is configured to receive, from the mediation server SV1, audio capability data DTA representative of whether said at least one second client terminal T2 has detected the digital marking code WT1 in an audio data stream FX received from the audio and/or video conference server SV1.

The control module MD8 is configured to trigger at least one action of managing the audio and/or video conference based on the received audio capability data DTA. As explained below, the one or more actions that are carried out may be of various kinds and may be adapted on a case-by-case basis. Said at least one management action may comprise for example rendering, via the user interface IU1 of the first client terminal T1, information dependent on the received audio capability data DTA and indicating whether said at least one second client terminal T2 is able to receive an audio data stream FX from the first client terminal T1.

The acoustic test module MD10 may furthermore be configured to carry out an acoustic test on the audio equipment of the first client terminal T1, in particular to carry out an acoustic test on the microphone MIC1 and/or on the loudspeaker HP1.

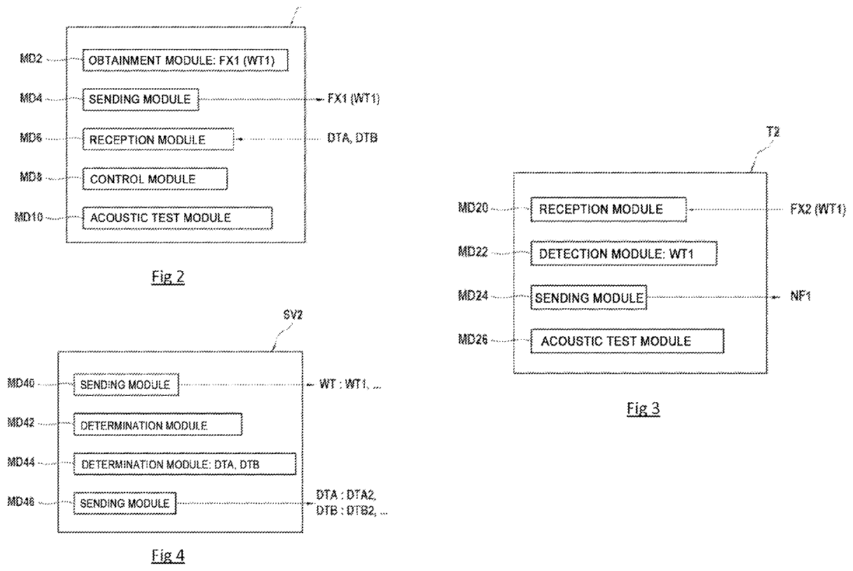

As shown in FIG. 3, according to one particular embodiment, the processor 10 driven by the computer program PG2 implements here a certain number of modules in the second client terminal T2, namely:

a reception module MD20, a detection module MD22, a sending module MD24, and possibly also an acoustic test module MD26.

The reception module MD20 is configured to receive, from the audio and/or video conference server, a marked audio data stream denoted FX2.

The detection module MD22 is configured to detect, in the marked audio stream FX2, a digital marking code WT (WT1 for example), the latter being integrated into the audio data stream FX2 by watermarking.

The sending module MD24 is configured to send, to the mediation server SV2, a notification indicating the detection of the digital marking code WT (WT1 for example), said notification comprising the digital marking code in association with the identifier ID2 of the second client terminal T2.

The acoustic test module MD26 may furthermore be configured to carry out an acoustic test on the audio equipment of the second client terminal T2, in particular to carry out an acoustic test on the microphone MIC2 and/or on the loudspeaker HP2.

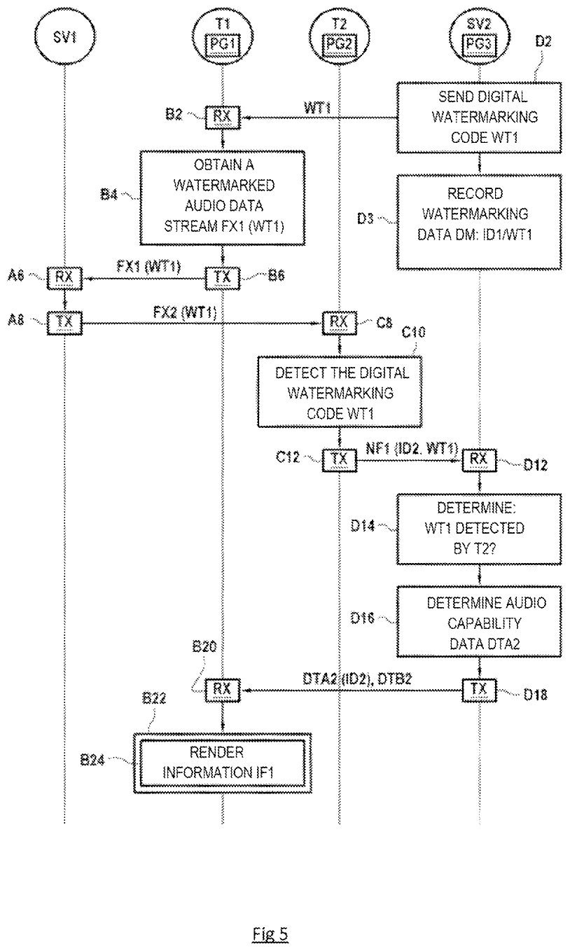

As shown in FIG. 4, according to one particular embodiment, the processor 20 driven by the computer program PG3 implements here a certain number of modules in the mediation server SV2, namely: a sending module MD40, a first determination module MD42, a second determination module MD44 and a sending module MD46.

The sending module MD40 is configured to send, to the first client terminal T1, a digital marking code WT1 assigned to the first client terminal T1 and to record, in marking data DM of the mediation server SV2, in association with the identifier ID1 of the first client terminal T1. In the example under consideration here, the marking data DM are stored in the non-volatile memory MR3.

The first determination module MD42 is configured to determine, based on the recorded marking data DM, whether a notification indicating that the second client terminal T2 has detected the marking code W1 is received from the second client terminal T2, this notification comprising the digital marking code W1 in association with the identifier ID2 of the second client terminal T2.

The second determination module MD44 is configured to determine, based on a result of the determination carried out by the first determination module MD42, audio capability data DTA2 indicating whether the second client terminal T2 is able to receive an audio data stream FX from the first client terminal T1.

The sending module MD46 is configured to send, to the first client terminal T1, the audio capability data DTA2 determined by the second determination module MD44.

According to one particular example, the sending module MD46 is furthermore configured to send, to the first client terminal T1, acoustic capability data DTB2 in relation to the second audio terminal T2, these acoustic capability data DTB2 being able to characterize the acoustic equipment of the second client terminal T2, and in particular its microphone MIC2 and/or its loudspeaker HP2.

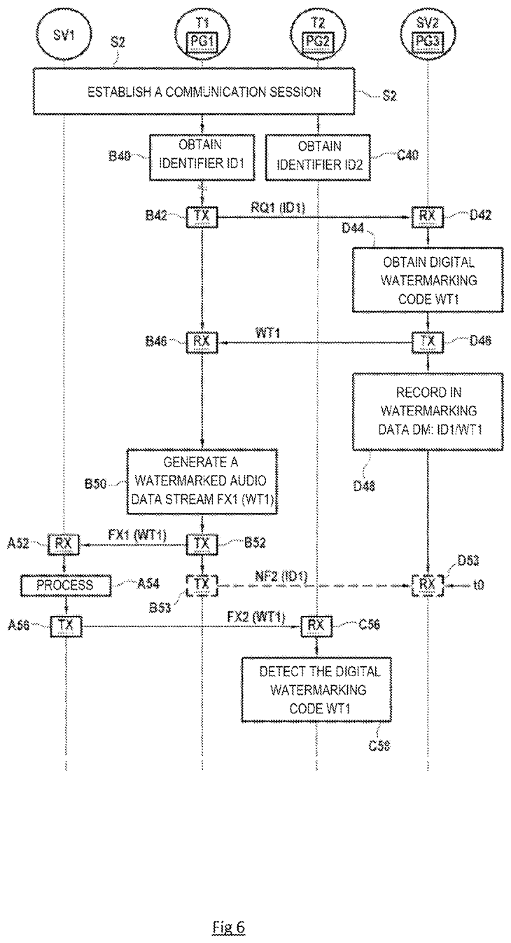

The configuration and the operation of the modules MD2-MD10 of the first client terminal T1, of the modules MD20-MD26 of the second client terminal T2 and of the modules MD40-MD46 of the mediation server SV2 will become more clearly apparent in the exemplary embodiments described below with reference to FIGS. 5-8. It should be noted that the modules MD2-MD10, MD20-MD26 and MD40-MD46 as shown in FIGS. 2-4 constitute only non-limiting exemplary implementations of the invention. One particular embodiment will now be described with reference to FIG. 5. More specifically, the first client terminal T1 and the second client terminal T2 as described above with reference to FIGS. 1-3 implement a first method and a second method, respectively, by executing the computer programs PG1 and PG2. These first and second methods collectively form a third method implemented by the system

SY1 shown in FIG. 1. In addition, the mediation server SV2 as described above with reference to FIGS. 1 and 4 implements a fourth method by executing the computer program PG3.

The users UR1 and UR2 use the client terminals T1 and T2, respectively, to communicate with one another, at least by audio, during an audio and/or video conference. To this end, it will be considered that a communication session is established by the client terminals T1 and T2 in cooperation with the audio and/or video conference server SV1 that manages the audio data streams FX between the first client terminal T1 and the second client terminal T2 during an audio and/or video conference.

According to one particular example, during a sending step D2 (FIG. 5), the mediation server SV2 sends a digital marking code WT1, which is received by the first client terminal T1 in B2. This digital marking code WT1, which may be in various forms, is assigned to the first client terminal T1. This digital marking code WT1 is a code (or marker) that may be integrated into an audio data stream by watermarking.

During an obtaining step B4, the first terminal T1 obtains an audio data stream FX1, these audio data being marked by integrating the digital marking code (also called “mark”) WT1 into an audio data stream, for example by watermarking. The watermarking technique makes it possible to insert marking information into host data, in this case audio data, such that for example this marking information is not perceptible (audible) to a user. To this end, the bits of the digital marking code are encoded into the audio data stream that serves as carrier signal.

According to one particular example, the first client terminal T1 determines or generates (B4) the marked audio data stream FX1 based on the digital marking code WT1 received in B2, by integrating the digital marking code WT1 into a first audio data stream by watermarking.

It should however be noted that variants in which the first client terminal T1 obtains the marked audio data stream FX1 in B4 in another way are possible. According to one particular example, the first client terminal T1 does not receive the digital marking code WT1 from the mediation server DV2, but obtains this code in B2 in another way, for example by consulting its memory MR1 in which said code WT1 is prerecorded. The first client terminal T1 may then insert the digital marking code WT1, for example by watermarking, into an audio data stream FX in order to obtain the marked audio data stream FX1. According to yet another variant, the marked audio data stream FX1 is prerecorded in a memory (for example MR1) of the first client terminal T1, and said first client terminal consults its memory to obtain the marked audio data stream FX1 in B4, such that the reception step B2 is not necessary either.

Regardless of the way in which the first client terminal T1 obtains (B4) the marked audio data stream FX1, it will be assumed that the mediation server SV2 records, in its memory (here the memory MR2), during a recording step D3 (FIG. 5), marking data DM associating the identifier ID1 of the first client terminal T1 with the digital marking code WT1 assigned to said first client terminal T1.

During a sending step B6, the first client terminal T1 sends the marked audio data stream FX1 to the conference server SV2. The conference server SV2 receives the marked audio data stream FX1 during a reception step A6.

The conference server SV1 then sends (step A8, FIG. 5), to the second client terminal T2, a second marked audio data stream FX2 comprising the digital marking code WT1, which is integrated for example by watermarking. To this end, the conference server SV1 determines beforehand the marked audio data stream FX2 based on processing of the marked audio data stream FX1 received in A6. In the example under consideration here, the marked audio data stream FX2 comprises the marked audio data stream FX1. In particular, the marked audio data stream FX2 may be a mixed audio data stream generated by the conference server SV1 by mixing (or combining) the marked audio data stream FX1 received in A6 with at least one other audio data stream transmitted by another client terminal, for example by the second client terminal T2. The mediation server SV2 is thus able to mix the audio streams from the various client terminals when the users speak or emit sounds so as to redistribute the audio streams to all participants.

According to one particular example, the conference server SV1 decodes (using codecs) each audio data stream that it receives from the client terminals (including the marked audio data stream FX1), and then mixes the audio data thus decoded to generate a mixed audio data stream, which mixed audio data are marked since they integrate the digital marking code WT1. The conference server SV1 then generates (using codecs) the marked audio data stream FX2 by re-encoding these mixed audio data.

It will now be considered that the second client terminal T2 receives, during a reception step C8, the marked audio data stream FX2 from the conference server SV1.

During a detection step C10, the second client terminal T2 then detects the digital marking code WT1 integrated into the marked audio data stream FX2, for example by watermarking. To this end, the second client terminal T2 analyzes the incoming audio data stream and checks whether this stream contains a digital marking code (or a mark). It will be assumed in this example that the second client terminal T2 is capable of recognizing a digital marking code WT but does not know the client terminal associated with each digital marking code WT (although other examples are possible).

It should be noted that it is not necessary for the second client terminal T2 to render the marked audio data stream FX2 in acoustic form by way of the loudspeaker HP2 in this example, although this is possible. However, it may be useful to acoustically render the audio stream FX2 when at least one of the participants in the audio and/or video conference is emitting sounds.

During a sending step C12, the second client terminal T2 sends, to the mediation server SV2, a notification NF1 indicating the detection of the digital marking code WT1, this notification NF1 comprising the digital marking code WT1 in association with the identifier ID2 of the second client terminal T1. The mediation server SV2 receives the notification NF1 during a reception step D12 (FIG. 5).

During a determination step D14, the mediation server SV2 determines, based on the marking data DM recorded in its memory MR3, whether a notification NF1—indicating that the second client terminal T2 has detected the digital marking code WT1—is received from the second client terminal T2, this notification NF1 comprising the digital marking code WT1 in association with the identifier ID2 of the second client terminal T2.

As described below, the execution of the fourth method by the mediation server SV2 may vary at this stage depending on the result of the determination step D14. The result of this step D14 may be positive (the mediation server SV2 detects the notification NF1) or negative (the mediation server SV2 does not detect the notification NF1). To this end, if the mediation server SV2 receives, from the second client terminal T2, a notification indicating the detection of a digital marking code, it consults its marking data DM in order to determine whether this notification comprises the digital marking code WT1 associated with the identifier ID1 in its marking data DM. If it does, the mediation server SV2 determines that the second client terminal T2, identified by the identifier ID2 contained in the received notification NF1, has detected the digital marking code WT1 associated with the first client terminal T1.

According to one particular example, the mediation server SV2 determines, in D14, absence of reception of the notification NF1 in D12 if no said notification, indicating that the second client terminal T2 has detected the digital marking code WT1, is received within a first period DL1 starting from a reference time to. In other words, if the first period DL1 expires without the notification NF1 having been received by the mediation server SV2, said mediation server detects that no notification NF1 indicating that the second client terminal T2 has detected the digital marking code WT1 has been received. As described in more detail below, this reference time may vary on a case-by-case basis, and may correspond for example to a time during which the sending D2 is carried out.

During a determination step D16, the mediation server SV2 then determines, based on a result of the determination D14, audio capability data DTA2 indicating whether the second client terminal T2 is able to receive an audio data stream FX from the first client terminal T1. In other words, the audio capability data DTA2 characterize the ability of the second client terminal T2 to receive an audio data stream FX transmitted by the first client terminal T1 during the audio and/or video conference.

Indeed, the detection, by the second client terminal T2, of the digital marking code WT1 indicates that the second client terminal T2 was able to receive the marked audio data stream FX2 comprising the marked audio data stream FX1 transmitted in B6 by the first client terminal T1. If it is determined in D14 that the notification NF1 has been received, the audio capability data DTA2 generated in D16 therefore indicate that the second client terminal T2 is able to receive an audio data stream transmitted by the first client terminal T1.

If the second client terminal T2 has not detected the digital marking code WT2, this means that it was unable to receive the marked audio data stream FX2 transmitted by the conference server SV1. In other words, a negative result of the determination D14 means that the test for reception of an audio stream from the first client terminal T1 to the second client terminal T2 has failed. Therefore, if it is determined in D14 that no notification NF1-indicating that the second client terminal T2 has detected the digital marking code WT1-has been received, the audio capability data DTA2 generated in D16 by the mediation server SV2 indicate that the second client terminal T2 is not able to receive an audio data stream from the first client terminal T1.

During this determination step D16, the mediation server SV2 may possibly update previous audio capability data DTA2 already stored in its memory MR3.

During a sending step D18, the mediation server SV2 then sends, to the first client terminal T1, the audio capability data DTA2 determined in D16. According to one particular example, the mediation server SV2 also sends (D18), to the first client terminal T1, acoustic capability data DTB representative of acoustic capabilities of the second loudspeaker HP2 coupled to the second client terminal T2 to produce an acoustic emission (or output). These acoustic capability data DTB may be obtained in various ways by the mediation server SV2, particular exemplary embodiments being described below. The first client terminal T1 receives the audio capability data DTA2, and where applicable the acoustic capability data DTB2, during a reception step B20. The received data may possibly be associated with the identifier ID2 of the second client terminal T2 in order to enable the first client terminal T1 to determine that they are data characterizing the second client terminal T2.

During a management step B22, the first client terminal T1 then triggers, based on the received capability data DTA2 (and possibly the acoustic capability data DTB2), at least one action of managing the audio and/or video conference in progress. The one or more management actions executed by the first client terminal T1 may vary on a case-by-case basis and consist in adapting the operation of the first client terminal T1 according to the ability or inability of the second client terminal T2 to receive an audio data stream transmitted by the first client terminal T1 (and possibly the ability to render the corresponding sounds) during the audio and/or video conference.

According to one particular example, during the management step B22, the first client terminal T1 renders (or outputs), by way of its user interface IU1, information IF1 that is dependent on the received audio capability data DTA2 (and also possibly on the received acoustic capability data DTB2), this information IF1 indicating whether the second client terminal T2 is able to receive an audio data stream FX (and possibly whether it is able to render the corresponding sounds). This rendering, which may take various forms (visual rendering, auditory rendering, etc.) may, at least in some embodiments, help the user UR1 to determine whether they are, or will be, heard well when they are speaking or emitting sounds during the audio and/or video conference.

According to one particular example, during the management step B22, the first client terminal T1 modifies at least one operating parameter or an audio configuration according to which it operates in order to exchange audio data streams in cooperation with the conference server SV1 during the conference.

According to one particular example, during the management step B22, the first client terminal T1 switches from the audio and/or video conference in progress to a second audio and/or video conference (backup or replacement conference) in which at least the terminals T1 and T2 also cooperate in order to exchange audio streams. The first terminal T1 may for example cooperate with at least the second client terminal T2 in several conferences simultaneously, or else in several successive conferences over a given period. In these two cases, switching to a new conference may allow the first client terminal T1 to solve an audio reception problem identified based on the data DTA2 (and possibly DTB2) received in B20 (FIG. 5).

According to one particular example, the conference server SV1 may send the mixed audio data stream FX2 to a plurality of second client terminals, for example to T2, T3 and T4. In this case, the client terminals T3 and T4 may process the marked audio data stream FX2 by executing steps C8-C12 in the same way as the second client terminal T2. The mediation server SV2 may then execute for example steps D12, D14 and D16 for at least one (for example each) of the second client terminals T2-T4 so as to generate, in D16, audio capability data DTA2, DTA3 and/or DTA4 respectively indicating whether said second client terminal has detected the digital marking code WT1 in an audio data stream received from the audio and/or video conference server SV1. The mediation server SV2 may thus send, in D18, to the first client terminal T1, the audio capability data DTA2, DTA3 and/or DTA4 (and also possibly acoustic capability data DTB2, DTB3 and DTB4 associated with the terminals T2, T3 and T4, respectively). The one or more management actions executed in B22 by the first client terminal T1 may thereby be dependent on the various received data.

As already indicated, it is not always easy for a user participating in an audio and/or video conference to know whether they are, or whether they will be, heard well by the other participants when they are speaking or when they are preparing to speak during an audio and/or video conference. Various hardware, software or other problems are likely to hinder the correct transmission of an audio stream from the client terminal of the speaker in question to the client terminals of other participants. The use, in at least some embodiments of the invention, of the digital marking technique (also known as watermarking) may help to reliably and robustly test the ability of client terminals to receive audio data streams from a given client terminal during an audio and/or video conference. The invention therefore makes it possible to limit the risks of a user speaking without being heard by another participant in the audio and/or video conference.

As described above, the invention involves a first client terminal sending an audio data stream integrating a digital marking code. A second third-party terminal is able to detect the marking code only if it has the ability to receive and correctly process the audio data stream from the first client terminal. If the second client terminal detects the digital marking code, it then informs the mediation server SV2 of this, which updates its audio capability data so that they indicate that the second client terminal is capable of receiving the audio data streams transmitted by the first terminal.

The digital marking technique may involve the use of an audio data stream to carry the digital marking code. The code, which may be inaudible to a user of the second client terminal, is used to reliably and securely mark the audio data stream in order to verify that transmission of the audio stream from the first client terminal to the second client terminal is operational.

As indicated above, the conference server SV1 is for example responsible for managing exchanges of audio data streams between the first client terminal T1 and the second client terminals T2-T4. In particular, the conference server SV1 may be configured to process all audio data streams transmitted by the client terminals so as to produce a mixed audio data stream FX2 that is distributed to all client terminals (or at least to the second client terminal T2). The processing carried out by the conference server SV1 may comprise in particular decoding the received audio data streams FX (including the stream FX1) and mixing these streams so as to produce a mixed audio data stream that is re-encoded before being sent to the client terminals. The digital watermarking technique may offer, at least in some embodiments, good robustness insofar as the digital marking code WT1 present in the received marked audio data stream FX1 (A6, FIG. 5) from the first client terminal T1 is resistant by nature to the various decoding, mixing, encoding, etc. processing operations carried out by the mediation server SV1. The mixed audio data stream FX2 sent in A8 to the second client terminal T2 thus comprises the same digital marking code WT1 as that present in the marked audio data stream FX1 received in A6 from the first client terminal T1.

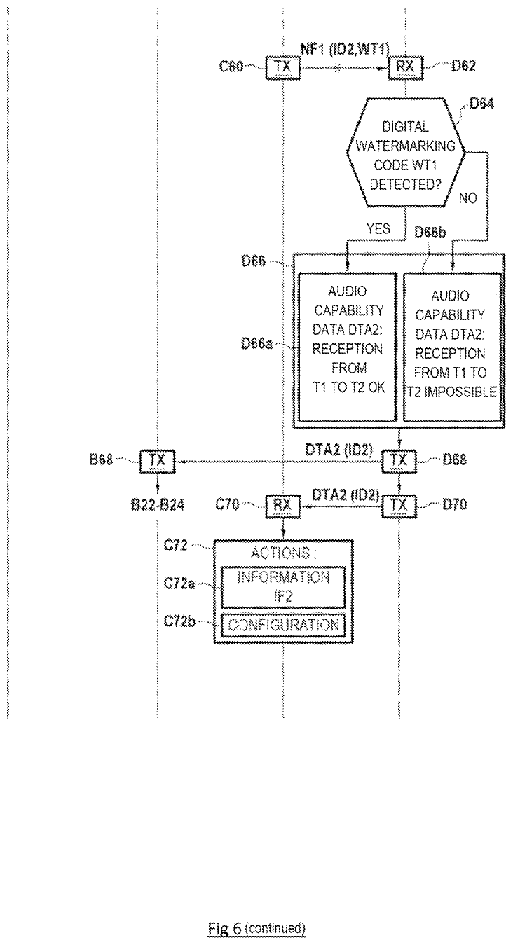

Particular exemplary implementations of the methods described above with reference to FIG. 5 will now be described in relation to FIGS. 6-8. To this end, the first client terminal T1 and the second client terminal T2 (FIGS. 1-3) execute the computer programs PG1 and PG2, respectively, in order to implement a first method and a second method. As already described, these first and second methods collectively form a third method implemented by the system SY1 shown in FIG. 1. In addition, the mediation server SV2 (FIGS. 1 and 4) implements a fourth method by executing the computer program PG3.

It will again be assumed that the users UR1 and UR2 using the client terminals T1 and T2, respectively, wish to communicate with one another, at least by audio, during an audio and/or video conference. To this end, during a session establishment step S2, the client terminals T1 and T2 each establish a communication session in cooperation with the conference server SV1 managing exchanges of audio data streams between the first client terminal T1 and the second client terminal T2.

It should be noted that, in the following exemplary embodiments, the first client terminal T1 tests the audio reception of a single second client terminal T2, although other examples in which the audio reception of at least two second client terminals T2 is tested are possible. In this case, each second client terminal executes the second method in the same way as the second client terminal T2.

During the establishment S2 of the communication sessions (or afterwards), a unique identifier ID is assigned to each client terminal participating in the audio and/or video conference. Thus, during obtaining steps B40 and C40, the first and second client terminals respectively obtain their respective identifier ID1 and ID2. The way in which these terminals obtain their unique identifier may vary on a case-by-case basis. According to one particular example, it is the conference server SV1 that transmits, to the client terminals T1 and T2, their respective identifier. According to another example, it is the users UR1 and UR2 who define the identifiers ID1 and ID2, respectively (or these are defined by default by their client terminal).

As already indicated, the first client terminal T1 may obtain (B4, FIG. 5) the marked audio data stream FX1 in various ways depending on the implementation under consideration. In this example, the first client terminal T1 sends (B42, FIG. 6), to the mediation server SV2, a digital marking code request RQ1 (or code demand request), this request RQ1 comprising the identifier ID1 of the first client terminal T1. The mediation server SV2 receives this request RQ1 during a reception step D42.

The mediation server SV2 then obtains (D44) a digital marking code WT1 assigned to the first client terminal T1. To this end, the mediation server SV2 may determine or generate the digital marking code WT1 in any appropriate way. This marking code WT1 may take various forms and may for example be a series of bits. The mediation server SV2 then sends (D46) the digital marking code WT1 to the first client terminal T1.

In response to the request RQ1, the first client terminal T1 thus receives, in B46, the digital marking code WT1 that is assigned thereto. According to one particular example, a distinct digital marking code WT is assigned by the mediation server SV2 to each second client terminal T2-T4.

During a recording step D48, the mediation server SV2 records, in marking data DM, the digital marking code WT1 in association with the identifier ID1 of the first client terminal T1. It should be noted that this recording step D48 may be carried out at various times, for example before or after the sending step D46, or even before step D4 of receiving the request RQ1 (in the latter case, the mediation server SV2 defined the association ID1/WT1 before the reception of the request RQ1).

According to one particular example, the first client terminal T1 determines, during the establishment

S2 of the communication session (or at the very least before the sending B42 of the request RQ1), an identifier IDC of the audio conference. The first client terminal T1 may then insert this identifier IDC of the audio and/or video conference into the request RQ1 before sending B42 to the mediation server SV2, so as to enable for example the mediation server SV2 to record the digital marking code WT1 in association with the identifier ID1 of the first client terminal T1 and the identifier IDC of the audio and/or video conference.

The identifier IDC of the conference enables the mediation server SV2 to recognize the requests associated with the audio and/or video conference in progress, to generate a unique digital marking code WT for at least one client terminal (or even for each of them) participating in said conference. The mediation server SV2 may thereby for example supervise the audio stream reception test for a plurality of distinct audio and/or video conferences, including when the first client terminal T1 participates in several conferences simultaneously or successively over a given period.

According to variants, the mediation server SV2 carries out steps D44, D46 and D48 without this being requested by the first client terminal T1, that is to say independently of any request RQ1 issued by the first client terminal T1.

Moreover, as already indicated, the first client terminal T1 may obtain the marked audio data stream FX1 in various ways. According to the example shown in FIG. 6, the first client terminal T1 generates or determines (B50) a marked audio data stream FX1 by integrating (or inserting) the digital marking code WT1 into a first audio data stream FX0, which serves as a carrier stream, by watermarking. This first audio data stream FX0 may be a test audio data stream, that is to say a stream in which the audio data are intended solely to test the audio reception of the second client terminal T2 and are not intended to be rendered by the second client terminal T2 to its user UR2.

According to one particular example, the first client terminal T1 generates the first audio data stream FX0 by emulating random noise. In this example, this emulation may be carried out while the microphone MIC1 of the first client terminal T1 is deactivated. It is thus possible to produce a carrier signal for the digital marking code WT1 even if no acoustic signal is acquired by the microphone MIC1 (for example when a mute function is activated).

According to one particular example, the first client terminal T1 generates the first audio data stream FX0 from payload audio data, that is to say from audio data transmitted by the first client terminal T1 during the audio and/or video conference and intended to be rendered by the second client terminal T2 to the user UR2. The first audio data stream FX0 may thus for example be generated from acoustic signals (or sounds) acquired by the first microphone MIC1 coupled to the first client terminal T1. This variant makes it possible to test the audio reception of the second client terminal T2 while the first client terminal T1 is picking up sounds (for example while the user UR1 is speaking during the audio and/or video conference).

According to one particular example, the acoustic signals from which the first audio data stream FX0 is generated represent (or result from) background noise acquired by the first microphone MIC1, the intensity of this background noise being less than a first intensity value 11. The marked audio data stream FX1 may then be generated in B50 from this background noise, for example when the user UR1 of the first client terminal T1 is not speaking. This value 11 may be adapted by those skilled in the art on a case-by-case basis.

According to one particular example, the first client terminal T1 triggers the sending B40 of the digital marking code request RQ1 upon detection, by way of its microphone MIC1, of a period of silence of a duration at least equal to a first duration D1, during which background noise of an intensity less than said first intensity value 11 is detected. A period of silence is for example detected when a mute function is activated, this function having the effect of deactivating the microphone MIC1 (blocking acoustic acquisition). The client terminal T1 thus requests a digital marking code WT1 only if the user UR1 is not speaking during the audio and/or video conference. It is thus possible for example to assist the user UR1 during the conference by informing them in advance whether they will be heard well by the second client terminal T2 if they decide to speak. This variant may help to save processing and network resources by carrying out an audio reception test only in order to predict the ability or inability of the second client terminal T2 to receive an audio data stream even before the first client terminal T1 transmits an audio data stream.

During a sending step B52, the first client terminal T1 then sends the marked audio data stream FX1 to the conference server SV1. As described below, this sending B52 causes the conference server SV1 to send, to the second client terminal T2, a marked audio data stream FX2 comprising the marked audio data stream FX1. The conference server SV1 receives the marked audio data stream FX1 during a reception step A52.

According to one particular example, the first client terminal T1 also sends, in B53, a notification NF2 informing of the sending B52 of the marked audio data stream FX1 to the conference server SV1 in order to carry out an audio test. This notification NF2, which may comprise the identifier ID1 of the first client terminal T1, is then received during a reception step D53. As described below, the reception D53 of the notification NF2 may mark, where applicable, a reference time to used thereafter by the mediation server SV2 during the fourth method.

The conference server SV1 then carries out processing (A54) based on the marked audio data stream FX1 received in A52, and possibly based on at least one other audio data stream FX transmitted by a client terminal other than the first client terminal T1, so as to produce a marked audio data stream FX2 comprising the digital marking code WT1. In this example, it will be considered that the conference server SV1 decodes each received audio data stream (including the stream FX1), mixes or combines the decoded audio data and encodes the mixed audio data so as to obtain a marked audio data stream FX2 comprising the digital marking code WT1.

During a sending step A56, the mediation server SV1 sends the marked audio data stream FX2 to the second client terminal T2. The second client terminal T2 receives the marked audio data stream FX2 in C56 and detects the digital marking code WT1 in this stream FX2 in C58, in a manner identical to steps C8 and C10 described above, respectively (FIG. 5).

As already indicated, the second client terminal T2 may render the marked audio data stream FX2 in acoustic form by way of the loudspeaker HP2 in this example, although variants without such sound rendering are possible. If the second client terminal T2 generates acoustic signals from the audio stream FX2, then the digital marking code WT2 may not be perceptible to the user UR2 (the code WT2 is not converted to sound), such that it does not interfere with listening during the conference.

During a sending step C60, the second client terminal T2 sends (in a manner identical to the sending C12, FIG. 5) a notification NF1 indicating that the second client terminal T2 has detected the digital marking code WT1, this notification NF1 comprising the digital marking code WT1 in association with the identifier ID2 of the second client terminal T2.

The mediation server SV2 receives the notification NF1 during a reception step D62.

In a manner identical to step D14 (FIG. 5), the mediation server SV2 then determines (D64) whether it has received a notification NF1 indicating that the second client terminal T2 has detected the digital marking code WT1. As already described, the mediation server SV2 may, to this end, consult its marking data DM and determine, in D64, whether the received notification NF1 comprises the digital marking code WT1 associated with the identifier ID1 of the first client terminal T1 in the marking data DM. The second client terminal T2 therefore does not need to know with which other client terminal the digital marking code WT1 is associated.

In some embodiments, as in this particular example, the mediation server SV2 uses a reference time t0 to determine, in D64, whether said notification NF1 is received within a first period DL1 starting from this reference time to. This reference time to may for example correspond to the reception D53 of the notification NF2 sent, where applicable, by the first client terminal T1 in order to prevent an audio test being carried out. It is thus possible for the mediation server SV2 to be informed when (for example each time that) the first client terminal T1 performs an audio test. Multiple audio tests may thus be carried out over time by the first client terminal T1 in order to test whether the user UR1 is, or will be, heard well by the second client terminal T2.

According to one variant, the mediation server SV2 is configured to ascertain, in advance, a reference time to during which the first client terminal T1 sends B52 the marked audio data stream FX1.

According to one variant, the mediation server SV2 uses, as reference time to, a time during which any one of steps D42, D44, D46 and D48 is carried out.

The mediation server SV2 thus determines that the result of the determination D64 is positive if it detects that the notification NF1 transmitted by the second client terminal T2 is received before expiry of a first period DL1 starting from this reference time to. If it is not, the mediation server SV2 determines that the result of the determination D64 is negative.

As already described with reference to step D16 (FIG. 5), the mediation server SV2 may then determine (D66), based on a result of the determination D64, audio capability data DTA2 indicating whether the second client terminal T2 is able to receive an audio data stream FX from the first client terminal T1. More specifically, if the result of the determination D64 is positive, the fourth method continues in step D66a, otherwise the fourth method continues in step D66b.

During step D66a, the mediation server SV2 determines, based on the positive result of the determination D64, audio capability data DTA2 indicating that the second client terminal T2 is able to receive an audio data stream from the first client terminal T1.

During step D66b, the mediation server SV2 determines, based on the negative result of the determination D64, audio capability data DTA2 indicating that the second client terminal T2 is not able to receive an audio data stream from the first client terminal T1.

The mediation server SV2 then sends (D68) the audio capability data DTA2 to the first client terminal T1 as already described with reference to step D18 (FIG. 5). The first client terminal T1 thus receives, in B68, the audio capability data DTA2 sent by the mediation server SV2. The first client terminal T1 may then carry out steps D22 and D24 in a manner identical to steps B20 and B22 as described above with reference to FIG. 5.

According to one particular example, in the event of a negative result of the determination D64 (no reception of the notification NF1 by the mediation server SV2), the mediation server SV2 may furthermore send (D70) the audio capability data DTA2 to the second terminal T2 in order to indicate thereto that its test for audio reception from the client terminal T1 to the second client terminal T2 has failed. The second client terminal T2 then receives the audio capability data DTA2 during a reception step C70. In response to the audio capability data DTA2, the second client terminal T2 may thus carry out at least one management action, such as for example rendering (C72a), by way of its user interface IU2, information IF2 indicating the failure of the audio reception test and/or modifying (C72b) an audio configuration of the second client terminal T2 with a view, if possible, to solving the audio reception problem. This audio configuration change may comprise for example reconfiguring any audio equipment of the second client terminal T2. Changing an audio configuration may comprise for example changing an audio input used by the second terminal T2 to receive audio data streams during the audio and/or video conference.

According to one particular example, the mediation server SV2 executes the fourth method according to steps D2-D18 (FIG. 5) or D42-D70 (FIG. 6) for a plurality of second client terminals, for example in cooperation with each of the terminals T2, T3 and T4, so as to send, in D68, to the first client terminal T1, audio capability data DTA2, DTA3 and DTA4 characterizing the second client terminals T2, T3 and T4, respectively. In particular, the mediation server SV2 may generate and transmit, in D68, to the first client terminal T1, an audio capability matrix indicating, for each second client terminal T2-T4, whether it has detected the digital marking code WT1 and therefore whether it is able to receive an audio data stream FX transmitted by the first client terminal T1 during the audio and/or video conference.

The first client terminal T1 may thus carry out step B22 (FIGS. 5-6) while taking into account the audio capability data DTA2, DTA3 and DTA4. In particular, the first client terminal T1 may render information IF1 indicating whether at least one (for example each) of the second client terminals T2, T3 and T4 is able to receive an audio data stream transmitted by the first client terminal T1 during the audio and/or video conference in progress. The user UR1 is thereby easily able to know whether they are, or will be, heard by each of the participants in the audio and/or video conference.

As already described above, the invention makes it possible to test the ability of one or more second client terminals to receive an audio data stream transmitted by the first client terminal during an audio and/or video conference. The invention therefore makes it possible to limit the risks of the user UR1 speaking without being heard by another participant in the audio and/or video conference.

However, even if for example the second client terminal T2 is actually capable of receiving an audio data stream FX transmitted by the first client terminal T1, problems related to the acoustic equipments of the first client terminal and/or of the second client terminal may be an obstacle in the audio communication transmission chain from the microphone MIC1 of the first client terminal T1 to the loudspeaker HP2 of the second client terminal T2. In this case, the user UR1 is not guaranteed that the user UR2 is able or will be able to hear them, even if the second client terminal T2 is capable of receiving an audio data stream transmitted by the first client terminal T1.

Therefore, according to one example, the invention may also comprise an acoustic test on at least one of the first client terminal T1 and the one or more second client terminals T2-T4 in order to supplement the audio capability data DTA2 generated by the mediation server SV2 (steps D16 and D66, FIGS. 5-6) with acoustic capability data DTB.

According to one example shown in FIG. 7, the first client terminal T1 carries out an acoustic test on the microphone MIC1 to which it is coupled (and more generally a test on the acoustic equipment of the first client terminal T1) by executing steps B80-B88 during the first method as described with reference to steps B2-B24 (FIG. 5) or to steps B40-B68 (FIG. 6). This test makes it possible, more generally, to test the entire acoustic chain (including the loudspeaker HP1 and the microphone MIC1) of the first client terminal T1.

More specifically, the first client terminal T1 activates (B80) its microphone MIC1, if it is not already active, and may possibly deactivate (B82) an echo cancellation function F1 if such a function is active. Specifically, an echo cancellation function is likely to hinder the orderly progress of the acoustic test on the microphone MIC1. In particular, the cancellation, where applicable, of an echo cancellation function F1 allows good acoustic acquisition by the microphone MIC1 of an acoustic emission (or output) from the loudspeaker HP1 coupled to the first client terminal T1.

During a generation step B84, the first client terminal T1 generates an acoustic test signal, denoted SA1 (FIG. 1), by way of the loudspeaker HP1. To this end, the first client terminal T1 may supply any test audio data stream at the input of the loudspeaker, so as to produce an acoustic test signal SA1 at the output of the loudspeaker HP1.

The acoustic test signal SA1 is preferably a signal (sound emission) inaudible to the human ear (for example in the high frequencies) so as not to disturb the user UR1 during the audio and/or video conference, but may possibly be an audible signal. According to one particular example, the acoustic test signal SA1 is transmitted at a frequency of at least 20 KHz. It may be a single-frequency signal or a sinusoidal signal, although other implementations are possible. By way of example, the acoustic test signal SA1 thus generated has a sampling frequency of at least 44.1 KHz.

The acoustic test signal SA1 is also transmitted preferably for a short time (for example for a maximum duration of 250 ms) in order to avoid potentially disturbing the user UR1 and so as to save resources and speed up the acoustic test process as far as possible while still ensuring that this acoustic test signal SA1 is able to be detected by the microphone MIC1.

During an acoustic acquisition step B86, the first client terminal T1 carries out an acoustic acquisition by way of the microphone MIC1 while the loudspeaker HP1 is transmitting the acoustic test signal SA1, so as to attempt to pick up this acoustic test signal SA1. The first client terminal T1 then determines (B88), based on a result of the acoustic acquisition B86, acoustic capability data DTB1 characterizing acoustic capabilities of the microphone MIC1 (and more generally of the acoustic equipment of the first client terminal T1).

More specifically, according to one example, the first client terminal T1 acquires, in B86, a test audio data stream DA1 that is produced by the microphone MIC1 from an acoustic signal picked up by said microphone. The first client terminal T1 then analyzes (B86), based on the test audio data stream DA1, an acoustic signal picked up by the microphone MIC1. The first client terminal T1 may in particular compare the picked-up acoustic signal, on the one hand, with the acoustic test signal SA1 generated in B84, on the other hand. Based on a result of this comparison, the first client terminal T1 evaluates whether there is a match between the picked-up acoustic signal and the acoustic test signal SA1. The acoustic capability data DTB1 may then be dependent on a degree of matching between these two signals. If there is a match, this means that the microphone MIC1 (and more generally the acoustic equipment of the first client terminal T1) is operational. If there is not, this means that the microphone MIC1 may be defective, or at the very least that the acoustic equipment of the first client terminal T1 is not operational.

The first client terminal T1 may thus carry out the management step B22 (FIGS. 5-6) also on the basis of the acoustic capability data DTB1 obtained in B88. As already indicated, the information IF1 rendered, where applicable, by the first client terminal T1 during the rendering step B24 may be representative not only of the received audio capability data DTA2 but also of the acoustic capability data DTB1 in relation to the first client terminal T1.

According to one example, during the management step B22, the first client terminal T1 may transmit, to the mediation server SV2, the acoustic capability data DTB1 obtained in B88. The mediation server SV2 may then also transmit these acoustic capability data DTB1 to the second client terminal T2, or more generally to each second client terminal T2-T4.

The acoustic test (B80-B88, FIG. 7) may be carried out at various stages of the first method implemented by the first client terminal T1 (FIGS. 5-6). According to one particular example, the first client terminal T1 triggers this acoustic test upon detection of the reception B2 (FIG. 5) or B46 (FIG. 6) of the digital marking code WT1 transmitted by the mediation server SV2, or at the very least before step B4 of obtaining (FIG. 5) or step B50 of generating (FIG. 6) the marked audio data stream FX1. Once the acoustic test on the first client terminal T1 is complete, the terminal T1 may reactivate, where applicable, the echo cancellation function F1 in order to avoid any disturbances to the acoustic acquisition of the microphone MIC1 during the audio and/or video conference.

The first client terminal T1 is for example configured to trigger the sending B6 or B52 of the marked audio data stream FX1 only if the acoustic test B80-B88 has taken place successfully, that is to say if it indicates that the microphone MIC1 is operational. Thus, if the acoustic test on the microphone MIC1 of the first client terminal T1 fails, said first client terminal does not continue the audio test, or possibly selects the technique of emulating random noise as described above to generate the marked audio data stream FX1 in B50 (FIG. 6). It is thus possible to save the resources of the client terminals T1 and T2, of the network and also those of the mediation server SV2 by avoiding needlessly executing an audio test from the first client terminal T1 even though its microphone MIC1 may be defective. The use of the emulation technique may furthermore help to ensure that the audio test is carried out correctly even though the microphone MIC1 may be defective.

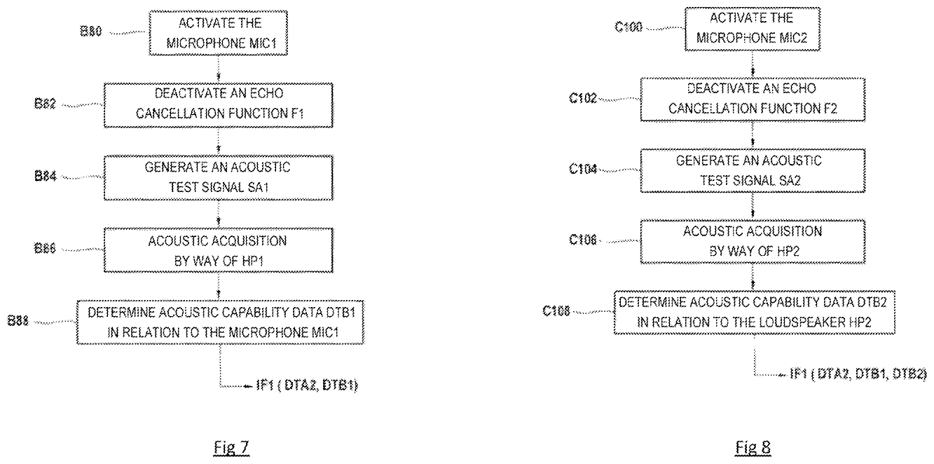

According to one example shown in FIG. 8, the first client terminal T1 carries out an acoustic test on the loudspeaker HP2 to which it is coupled (and more generally a test on the acoustic equipment of the second client terminal T2) by executing steps C100-C108 during the second method as described with reference to steps C8-C12 (FIG. 5) or to steps C40-C72 (FIG. 6). This acoustic test C100-C108 is carried out analogously to the acoustic test B80-B88 on the first client terminal T1 as described above. This test makes it possible more generally to test the entire acoustic chain (including the loudspeaker HP2 and the microphone MIC2) of the second client terminal T2.

More specifically, the second client terminal T2 activates (C100) its microphone MIC2, if it is not already active, and may possibly deactivate (C102) an echo cancellation function F2 if such a function is active. Specifically, an echo cancellation function is likely to hinder the orderly progress of the acoustic test on the loudspeaker HP2. In particular, the cancellation, where applicable, of an echo cancellation function F2 allows good acoustic acquisition by the microphone MIC2 of an acoustic emission (or output) from the loudspeaker HP2 coupled to the second client terminal T2.

During a generation step C104, the second client terminal T2 generates an acoustic test signal, denoted SA2 (FIG. 1), by way of the loudspeaker HP2. To this end, the second client terminal T2 may supply any test audio data stream at the input of the loudspeaker HP2, so as to produce an acoustic test signal SA2 at the output of the loudspeaker HP2.

The acoustic test signal SA2 is preferably a signal inaudible to the human ear (for example in the high frequencies) so as not to disturb the user UR2 during the audio and/or video conference, but may possibly be an audible signal. According to one particular example, the acoustic test signal SA2 is transmitted at a frequency of at least 20 KHz. It may be a single-frequency signal or a sinusoidal signal, although other implementations are possible. By way of example, the acoustic test signal SA2 thus generated has a sampling frequency of at least 44.1 KHz.

The acoustic test signal SA2 is also transmitted preferably for a short time (for example for a maximum duration of 250 ms) in order to avoid potentially disturbing the user UR1 and so as to save resources and speed up the acoustic test process as far as possible, while still ensuring that this acoustic test signal SA2 is able to be detected by the microphone MIC2.

During an acoustic acquisition step C106, the second client terminal T2 carries out an acoustic acquisition by way of the microphone MIC2 while the loudspeaker HP2 is transmitting the acoustic test signal SA2, so as to attempt to pick up this acoustic test signal SA2. The second client terminal T2 then determines (C108), based on a result of the acoustic acquisition C106, acoustic capability data DTB2 characterizing acoustic capabilities of the loudspeaker HP2 (and more generally of the acoustic equipment of the second client terminal T2).

More specifically, according to one example, the second client terminal T2 acquires, in C106, a test audio data stream DA2 that is produced by the microphone MIC2 from an acoustic signal picked up by said microphone. The second client terminal T2 then analyzes (C106), based on the test audio data stream DA2, an acoustic signal picked up by the microphone MIC2. The second client terminal T2 may in particular compare the picked-up acoustic signal, on the one hand, with the acoustic test signal SA2 generated in C104, on the other hand. Based on a result of this comparison, the second client terminal T2 evaluates whether there is a match between the picked-up acoustic signal and the acoustic test signal SA2. The acoustic capability data DTB2 may then be dependent on a degree of matching between these two signals. If there is a match, this means that the loudspeaker HP2 (and more generally the acoustic equipment of the first client terminal T1) is operational. If there is not, this means that the loudspeaker HP2 may be defective, or at the very least that the acoustic equipment of the second client terminal T2 is not operational.

According to one example, the second client terminal T2 may transmit, to the mediation server SV2, the acoustic capability data DTB2 obtained in C108. The mediation server SV2 may then also transmit these acoustic capability data DTB1 to the first client terminal T1, or more generally to each other client terminal T1, T3 and T4 participating in the audio and/or video conference.

The first client terminal T1 may thus carry out the management step B22 (FIGS. 5-6) also on the basis of the acoustic capability data DTB2 received from the mediation server SV2. As already indicated, the information IF1 rendered, where applicable, by the first client terminal T1 during the rendering step B24 may also be representative of the acoustic capability data DTB2 in relation to the second client terminal T2.

The acoustic test (C100-C108, FIG. 8) may be carried out at various stages of the second method implemented by the second client terminal T2 (FIGS. 5-6). Once the acoustic test on the second client terminal T2 is complete, the terminal T2 may reactivate, where applicable, the echo cancellation function F2 in order to avoid any disturbances to the acoustic acquisition of the microphone MIC1 during the audio and/or video conference.

According to one example, each client terminal participating in the audio and/or video conference may trigger an acoustic test on its own acoustic equipment (including its microphone and loudspeaker), for example during (or in response to) the establishment S2 (FIG. 6) of the communication session with the conference server SV1. In this case, each client terminal sends, to the mediation server SV2, acoustic capability data DTB representative of its own acoustic capabilities. The acoustic capability data obtained by each client terminal may thus be indicative of the ability of said client terminal to:
produce an acoustic emission (or output) by way of a microphone coupled to said client terminal, from an audio data stream received from the audio and/or video conference server SV1; and
acoustically acquire an acoustic signal by way of a loudspeaker coupled to said client terminal.

Moreover, all or part of the first method as described above with reference in particular to FIGS. 5-6 may be reiterated a plurality of times by the first client terminal T1. According to one particular example, at least some of steps B4-B22 (or even B2-B24) are reiterated during the communication session, so as to check, multiple times (for example periodically), whether said at least one second client terminal T2-T4 is able to receive an audio data stream FX transmitted by the first client terminal T1. It is thus possible to monitor the audio capabilities of one or more second terminals T2-T4 over time, in particular while the user UR1 of the client terminal T1 is speaking or is silent. The periodic or regular reiteration of the first method may in particular make it possible to continuously or repeatedly monitor the ability of one or more second terminals to receive an audio data stream transmitted by the first client terminal T1.

It should be noted that it is possible to reiterate the first method of the invention multiple times using the same digital marking code WT1, or even using the same marked audio data stream FX1 (in the case for example of an emulated carrier signal). It is thus possible to carry out a plurality of audio tests while saving the necessary resources. As a variant, the client terminal T1 uses at least two distinct digital marking codes WT1 to implement a plurality of iterations of the first method. Changing the digital marking code WT1 during multiple iterations of the first method may help to ensure better robustness of the audio test (for example improved security of the test process in the event of interception and unauthorized use of a digital marking code by a third party, possibility of using multiple different types of marking code for greater flexibility, etc.).

As already indicated with reference to FIG. 5, the second client terminal T2 may in particular modify its audio configuration upon reception of audio capability data DTA2 indicating that said second client terminal T2 is not able to receive an audio data stream transmitted by the first client terminal T1. According to one particular example, the first client terminal T1 carries out the following steps for each of a plurality of audio configurations, for as long as a first audio condition is not satisfied: configuring the first client terminal T1 in accordance with said audio configuration; and reiterating at least part of the first method as described above (steps B2-B24).

Likewise, as already indicated with reference to FIG. 6, the second client terminal T2 may in particular modify its audio configuration upon reception of audio capability data DTA2 indicating that said second client terminal T2 is not able to receive an audio data stream transmitted by the first client terminal T1. According to one particular example, the second client terminal T2 carries out the following steps for each of a plurality of audio configurations, for as long as a second audio condition is not satisfied:

configuring the second client terminal T2 in accordance with said audio configuration; and reiterating at least some of steps C56-C72 of the second method (FIG. 6).

The first and/or second client terminals may thus test each possible audio configuration until a positive audio test is obtained.

According to one particular example, each client terminal T1-T4 (acting as first client terminal) may thus implement the first method as described above with reference to FIGS. 5-8 so as to test the ability of each other client terminal (acting as second client terminal) to receive an audio data stream transmitted by said client terminal. The mediation server SV2 may for example generate a capability matrix comprising audio capability data DTA associated with each client terminal, these data indicating whether an audio stream transmitted by said client terminal is able to be received by each other client terminal. The capability matrix may possibly also comprise acoustic capability data DTB characterizing acoustic capabilities of each client terminal. In other words, this capability matrix may be obtained by supplementing the audio capability matrix described above with the acoustic capability data DTB in relation to the client terminals.

The mediation server SV2 may furthermore transmit this capability matrix to at least one (for example each) client terminal T1-T4 so that said client terminal manages the audio and/or video conference by adapting its operation accordingly.

It should moreover be noted that the order in which the steps of the various methods described above are chained together constitutes only non-limiting exemplary embodiments, with variants being possible.

Those skilled in the art will understand that the embodiments and variants described above constitute only non-limiting exemplary implementations of the invention. In particular, those skilled in the art may envisage any adaptation or combination of the embodiments and variants described above in order to meet a very specific need in accordance with the claims presented below.

1. A method implemented by a first client terminal during a communication session in cooperation with an audio and/or video conference server managing exchanges of audio data streams between the first client terminal and at least one second client terminal during an audio and/or video conference, the method comprising:
sending, to the audio and/or video conference server, a marked audio data stream, the audio data being marked by integrating a code assigned to said first terminal into a first audio data stream;
receiving audio capability data representative of whether said at least one second client terminal has detected the code assigned to said first terminal in an audio data stream received from the audio and/or video conference server; and
triggering at least one action of managing the audio and/or video conference based on the received audio capability data, said at least one management action comprising rendering, via a user interface of the first client terminal, information, dependent on the received audio capability data, indicating whether said at least one second client terminal is able to receive an audio data stream from the first client terminal.

2. The method of claim 1, further comprising receiving, from a mediation server, the code assigned to the first client terminal.

3. The method of claim 2, wherein said code assigned to said first client terminal is received in response to a request to said mediation server comprising an identifier of the first client terminal.

4. The method of claim 1, wherein the first audio data stream is generated from acoustic signals acquired by a first microphone coupled to the first client terminal.

5. The method of claim 4, wherein the acoustic signals from which the first audio data stream is generated represent background noise acquired by the first microphone, the intensity of the background noise being less than a first intensity value.

6. The method of claim 1, wherein the first audio data stream is generated by emulating random noise.

7. The method of claim 1, further comprising, before sending the marked audio data stream to the audio and/or video conference server:
activating a first microphone of the first client terminal;
deactivating an echo cancellation function (F1) so as to allow acoustic acquisition, by the first microphone of the first client terminal, of an acoustic emission from a first loudspeaker coupled to said at least one first client terminal;
generating an acoustic test signal by way of the first loudspeaker (HP1);
acoustically acquiring, by way of the first microphone, the acoustic test signal transmitted by the first loudspeaker; and
determining, based on a result of said acoustic acquisition, acoustic capability data characterizing acoustic capabilities of the first microphone;
wherein the information rendered by the user interface is furthermore representative of the acoustic capabilities of the first microphone of the first client terminal.

8. A method implemented by a second client terminal during a communication session in cooperation with an audio and/or video conference server managing exchanges of audio data streams between a first client terminal and the second client terminal during an audio and/or video conference, the method comprising:
receiving, from the audio and/or video conference server, an audio data stream; and
sending a notification comprising a code integrated into said received audio data stream, in association with an identifier of the second client terminal.

9. The method as claimed in claim 8, further comprising, upon detection of said code in said received audio data stream:
activating a second microphone coupled to the second client terminal;
deactivating an echo cancellation function so as to allow acoustic acquisition, by the second microphone, of an acoustic emission from a second loudspeaker coupled to said second client terminal;
generating an acoustic test signal by way of the second loudspeaker;
acoustically acquiring, by way of the second microphone, the acoustic test signal transmitted by the second loudspeaker;
determining, based on a result of said acoustic acquisition, acoustic capabilities of the second loudspeaker of the second client terminal to produce an acoustic emission; and
sending the acoustic capabilities of the second loudspeaker to the mediation server.

10. A mediation method implemented by a mediation server in cooperation with a plurality of client terminals participating in an audio and/or video conference during which audio data streams are exchanged via an audio and/or video conference server, the method comprising:
sending, to a first client terminal of the plurality of terminals, a code assigned to the first client terminal and recorded, in association with an identifier of the first client terminal; and
upon receipt, from a second client terminal of the plurality of terminals, of a notification comprising the code assigned to said first client terminal in association with an identifier of the second client terminal:
determining audio capability data indicating whether the second client terminal is able to receive an audio data stream from the first client terminal; and
sending said audio capability data to the first client terminal.

11. The method of claim 10, wherein absence of reception of said notification is determined if no said notification, indicating that the second client terminal has detected the code assigned to said first terminal, is received within a first period starting from a reference time.

12. A client terminal comprising at least one processor configured to implement the method of claim 1.

13. A system comprising:
a first client terminal comprising at least one first processor configured to implement the method of claim 1; and
at least one second client terminal, comprising at least one second processor configured to implement a method during the communication session in cooperation with the audio and/or video conference server managing exchanges of audio data streams between the first client terminal and the second client terminal during the audio and/or video conference, the method comprising:
receiving, from the audio and/or video conference server, said audio data stream; and
sending a notification comprising said code integrated into said received audio data stream, in association with an identifier of the second client terminal
said information rendered by the first client terminal indicating that the second client terminal is able to receive an audio data stream transmitted by the first client terminal.

14. A mediation server comprising at least one processor configured to implement the method of claim 1.

15. The method of claim 1, further comprising obtaining the marked audio data stream, the audio data being marked by integrating a digital marking code into a first audio data stream by watermarking, wherein the audio capability audio capability data representative of whether said at least one second client terminal has detected the digital marking code in an audio data stream received from the audio and/or video conference server is received from a mediation server.

16. The method of claim 15, wherein obtaining the marked audio data stream, further comprises:
sending, to a mediation server, a digital marking code request, said request comprising an identifier of the first client terminal; and
receiving, in response to said request, the digital marking code assigned to the first client terminal.

17. The method of claim 16, further comprising
determining, when establishing the communication session, an identifier of the audio and/or video conference; and
inserting, into the digital marking code request, the identifier of the audio conference before sending to the mediation server, so as to enable said mediation server to record the digital marking code in association with the identifier of the first client terminal and the identifier of the audio and/or video conference.

18. The method of claim 1, wherein the first audio data stream is generated from acoustic signals acquired by a first microphone coupled to the first client terminal.

19. The method of claim 18, wherein the acoustic signals from which the first audio data stream is generated represent background noise acquired by the first microphone, the intensity of the background noise being less than a first intensity value.

20. A client terminal comprising at least one processor configured to implement the method of claim 8.
